(19) United States
(12) Patent Application Publication
(10) Pub. No.: US 2003/0223194 A1
(43) Pub. Date: Dec. 4, 2003

(54) Tower PC with maximum utilization of internal volume

(76) Inventor: Michael Schmid, Dillingen (DE)

Correspondence Address: LERNER AND GREENBERG, P.A., POST OFFICE BOX 2480, HOLLYWOOD, FL, 33022-2480, US

(21) Appl. No.: 10/437,785

(22) Filed: May 14, 2003

(30) Foreign Application Priority Data
May 31, 2002 (DE) 102 24 274.7

(51) Int. Cl. G06F 1/16

(52) U.S. Cl. 361/687; 361/683

(57) ABSTRACT

The invention relates to a tower PC having a computer casing with a motherboard, a microprocessor, plug-in cards, a mounting cradle for 3½″ drives, a mounting cradle for 5¼″ drives and a power supply configured therein in order to optimize space utilization and cooling.

### BACKGROUND OF THE INVENTION

### FIELD OF THE INVENTION

The invention relates to a design concept for a tower PC (personal computer) having a computer casing with a motherboard, a microprocessor, plug-in cards, a mounting cradle for 3½″ drives, a mounting cradle for 5¼″ drives and a power supply configured therein.

### SUMMARY OF THE INVENTION

It is accordingly an object of the invention to provide a tower PC having a computer casing with a motherboard, a microprocessor, plug-in cards, a mounting cradle for 3½″ drives, a mounting cradle for 5¼″ drives and a power supply configured therein such that the external dimensions can be optimized while utilizing the internal dimensions to the greatest extent.

With the foregoing and other objects in view there is provided, in accordance with the invention, a tower personal computer including: a computer casing having a front; a motherboard configured in the computer casing; a microprocessor configured in the computer casing; a plurality of plug-in cards configured in the computer casing; a mounting cradle for 3½″ drives, the mounting cradle for 3½″ drives configured in the computer casing; a mounting cradle for 5¼″ drives, the mounting cradle for 5¼″ drives configured in the computer casing; and a power supply configured in the computer casing. The mounting cradle for 3½″ drives is configured below the mounting cradle for 5¼″ drives at the front of the computer casing. The mounting cradle for 3½″ drives is configured transversely with respect to the mounting cradle for 5¼″ drives.

In accordance with an added feature of the invention, the computer casing has a back located opposite the front; and the computer casing has a ventilation grille configured at the front and a ventilation grille configured at the back.

In accordance with an additional feature of the invention, the computer casing includes: a first region containing the power supply and the microprocessor; and a second region containing the plurality of plug-in cards and the mounting cradle for 3½″ components. An airshield is configured between the first region and the second region.

In accordance with another feature of the invention, a fan is configured between the mounting cradle for 3½″ drives and the plurality of plug-in cards.

In accordance with a further feature of the invention, an air guide shroud is provided for passively cooling the microprocessor. The power supply provides cooling air to the air guide shroud.

The object of the invention is inventively achieved by configuring the mounting cradle for the 3½″ drives below the mounting cradle for the 5¼″ drives and mounting the lower mounting cradle transversely with respect to the top mounting cradle.

Since the 3½″ drives are arranged transversely, the internal volume of the computer casing is better utilized. The 3½″ drives are as long as the 5¼″ drives are wide, and hence essentially the entire width of the computer casing is used.

In addition, this arrangement means that the 3½″ drives can easily be installed or replaced when the side shroud has been removed.

Improved cooling of the components is achieved by providing a ventilation grille at the front of the computer casing and by providing a ventilation grille at the back next to the I/O panel. The ventilation grille at the front is arranged at the same height as the 3½″ drives.

The fact that the 3½″ drives are installed transversely means that the 3.5 inch connecting cable for the drives runs parallel to the side of the computer casing at the back of the components. This means that the cooling air stream flows only to one narrow longitudinal side of the connecting cable and not, as in the case of installation from the front, to the breadth of the connecting cable. This impedes the cooling air stream to a much lesser extent, which increases the cooling efficiency.

In addition, there is a fan between the 3½″ drives and the plug-in cards, and this fan, together with the two ventilation grilles at the front and back, ensures optimum cooling. The fan can also be arranged between the 3½″ drives and the ventilation grille at the front.

Cooling is enhanced by providing a plastic partition, subsequently called an airshield, which divides the computer casing into a top and a bottom region. The airshield is located parallel to the plug-in cards and, together with the ventilation grilles at the front and back, forms a ventilation channel over the entire length of the computer casing.

Other features which are considered as characteristic for the invention are set forth in the appended claims.

Although the invention is illustrated and described herein as embodied in a design concept for a tower PC, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a side view of a computer casing open at the side; and

FIG. 2 is a rear view of the computer casing shown in FIG. 1.

### DESCRIPTION OF THE PREFERRED EMBODIMENTS

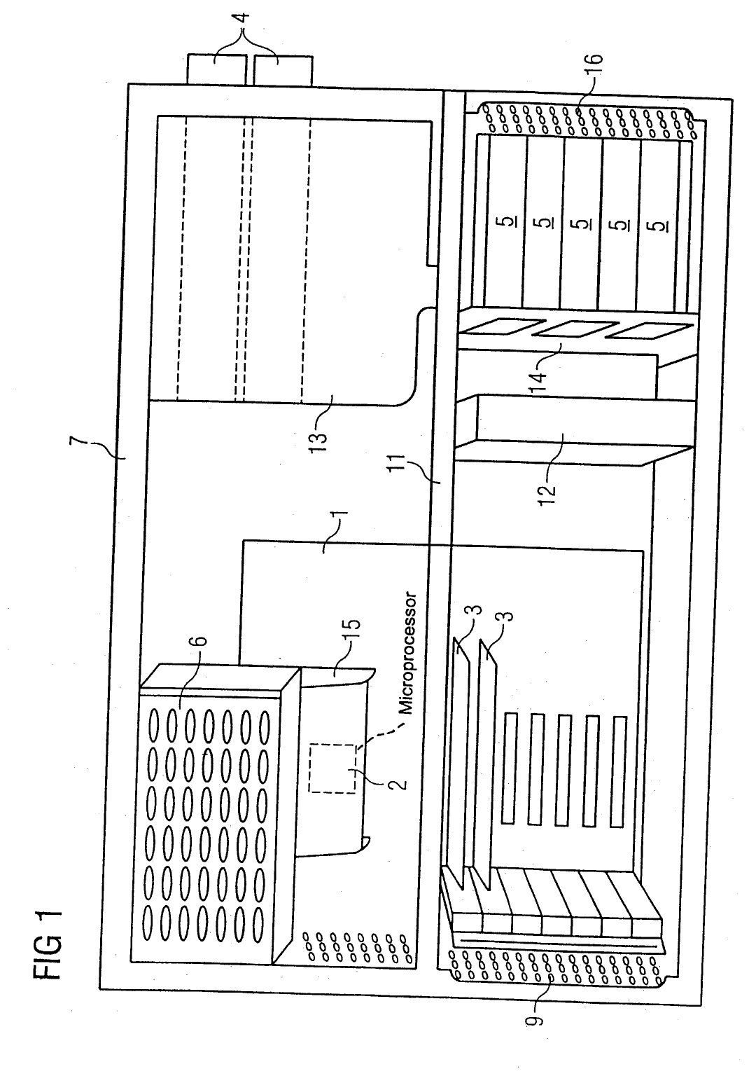

Referring now to the figures of the drawing in detail and first, particularly, to FIG. 1 thereof, there is shown a side view of a computer casing 7 with the side removed. The computer casing 7 contains a mounting cradle 13 for 5¼″ drives 4 at the top behind the front. The 5¼″ drives 4 are installed via the front of the computer casing 7 and are operated from the front. Below the mounting cradle 13, there is a further mounting cradle 14 for 3½″ drives 5. The 3½″ drives 5 are installed transversely in the computer with the side removed. This arrangement means that the 3½″ drives 5 are arranged in a highly space-saving manner, which makes it possible to reduce the volume of the computer casing to 36 liters when using a standard ATX motherboard with seven PCI slots.

The rear region of the computer casing 7 contains a vertically arranged motherboard 1 whose top half holds a microprocessor 2 and whose bottom half has plug-in cards 3 plugged into it.

The computer casing 7 is split into a top and a bottom region by an airshield 11. The airshield 11 extends almost over the entire width of the computer casing 7 and from the back of the computer casing 7 to the 3½″ drives 5 or to the front of the computer, running in between the mounting cradles 13 and 14. The airshield 11 is arranged parallel to the plug-in cards 3.

The airshield 11 prevents the heat from the 3½″ drives 5, generally the hard disks, from being able to flow upward into the region of the motherboard 1, where the processor 2 is arranged.

A power supply 6 is configured above the airshield 11. The power supply 6 can be used to passively cool the processor 2 by using an air guide shroud 15 connecting the power supply 6 and the processor 2, so that the air cooling for the power supply 6 is enough to cool the processor 2.

There is a fan 12 below the airshield 11, between the 3½″ drives 5 and the plug-in cards 3.

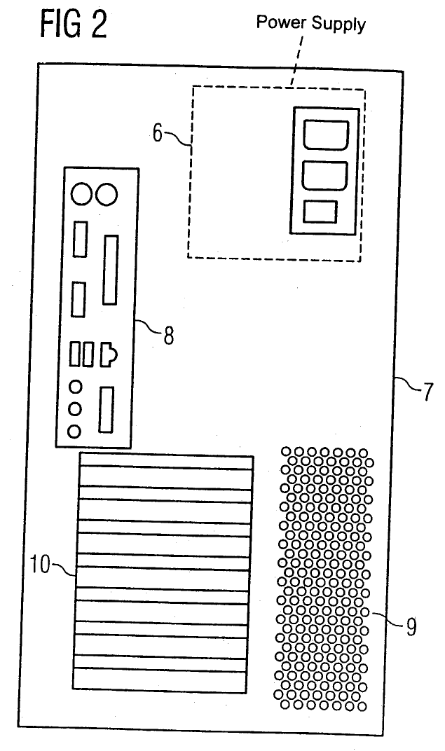

FIG. 2 is a rear view of a computer casing 7 with a plug panel 8, an I/O panel 10, a ventilation grille 9 and the power supply 6.

The front of the computer casing 7 has a ventilation grille 16 at the same height as the back (see FIG. 1). The ventilation grille 9 at the back, the airshield 11, and the fan 12, form a cooling channel containing the 3½″ drives and the plug-in cards 3.

The fan 12 can also be arranged between the mounting cradle 14 and the ventilation grille 16.

I claim:

1. A tower personal computer, comprising:
a computer casing having a front;
a motherboard configured in said computer casing;
a microprocessor configured in said computer casing;
a plurality of plug-in cards configured in said computer casing;
a mounting cradle for 3½″ drives, said mounting cradle for 3½″ drives configured in said computer casing;
a mounting cradle for 5¼″ drives, said mounting cradle for 5¼″ drives configured in said computer casing; and
a power supply configured in said computer casing;
said mounting cradle for 3½″ drives configured below said mounting cradle for 5¼″ drives at said front of said computer casing; and
said mounting cradle for 3½″ drives configured transversely with respect to said mounting cradle for 5¼″ drives.

2. The tower personal computer according to claim 1, wherein:
said computer casing has a back located opposite said front; and
said computer casing has a ventilation grille configured at said front and a ventilation grille configured at said back.

3. The tower personal computer according to claim 1, further comprising:
an airshield;
said computer casing including a first region containing said power supply and said microprocessor;
said computer casing including a second region containing said plurality of plug-in cards and said mounting cradle for 3½″ components; and
said airshield; configured between said first region and said second region.

4. The tower personal computer according to claim 1, further comprising a fan configured between said mounting cradle for 3½″ drives and said plurality of plug-in cards.

5. The tower personal computer according to claim 1, further comprising:
an air guide shroud for passively cooling said microprocessor;
said power supply for providing cooling air to said air guide shroud.
